(19) United States
(12) Patent Application Publication
(10) Pub. No.: US 2007/0211383 A1
(43) Pub. Date: Sep. 13, 2007

(54) Perpendicular magnetic recording head and method of manufacturing the same

(75) Inventors: Kook-hyun Sunwoo, Yongin-si (KR); kyoung-won Na, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/713,663

(22) Filed: Mar. 5, 2007

(30) Foreign Application Priority Data
Mar. 6, 2006 (KR) 10-2006-0021065

(51) Int. Cl. G11B 5/147

(52) U.S. Cl. 360/126

(57) ABSTRACT

A perpendicular magnetic recording head and a method of manufacturing the same are provided. The perpendicular magnetic recording head includes a main pole, a return yoke, and a coil which generates a magnetic field such that the main pole may record information on a recording medium. The coil has a structure that surrounds the main pole in a solenoid shape.

### CROSS-REFERENCE TO RELATED PATENT APPLICATION

This application claims priority from Korean Patent Application No. 10-2006-0021065, filed on Mar. 6, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to a perpendicular magnetic recording head, and more particularly, to a perpendicular magnetic head and a method of manufacturing the same, the perpendicular magnetic head including a coil formed around a main pole and having a solenoid structure for generating a magnetic field to improve the strength of a recording field of a perpendicular magnetic recording head and thus improve the recording density of a recording medium.

2. Description of the Related Art

As the amount of information handled by individuals and various organizations has rapidly increased, computers having high information processing speed and large data storage capacity have been required. Thus, a central processing unit (CPU) and peripheral devices have been upgraded in order to increase the data processing speed of a computer. Also, a variety of high-density information storage media have been introduced in order to increase data storage capability. The most generally and widely used information recording medium is a magnetic recording medium having a magnetic layer as a data recording layer.

Magnetic recording methods can be classified into longitudinal magnetic recording methods and perpendicular magnetic recording methods. In the longitudinal magnetic recording methods, data is recorded by aligning a magnetization direction of a magnetic layer, which is a recording layer, in a parallel direction to a surface of the magnetic layer. On the other hand, in the perpendicular magnetic recording methods, data is recorded by aligning a magnetization direction of a magnetic layer in a direction perpendicular to a surface of the magnetic layer. In general, the data recording density of the perpendicular magnetic recording methods is greater than that of the longitudinal magnetic recording methods.

FIG. 1A is a view illustrating a related art perpendicular magnetic recording apparatus. Referring to FIG. 1A, the related art perpendicular magnetic recording apparatus includes a perpendicular magnetic recording medium 10, a recording head 100 recording data on the perpendicular recording medium 10, and a reproduction head 110 reproducing data from the perpendicular magnetic recording medium 10.

The recording head 100 includes a main pole P1, a return yoke P2, and a coil C. Each of the main pole P1 and the return yoke P2 may be formed of a magnetic material such as NiFe. The saturation magnetic flux density Bs of the main pole P1 may be different from that of the return yoke P2 by using different composition ratios of the magnetic material. The main pole P1 and the return yoke P2 are used for recording data on a recording layer 13 of the perpendicular magnetic recording medium 10. A sub-yoke 101 may be further formed on a lateral side of the main pole P1 to gather a magnetic field generated from the main pole P1 on a selected region of the perpendicular magnetic recording medium 10 during a data-recording process. The coil C generates a magnetic field so that the main pole P1 may record information on the recording medium 10.

The reproduction head 110 includes a first magnetic shield layer S1, a second magnetic shield layer S2, and a magnetoresistance device 111 for data reproduction interposed between the first and second magnetic shield layers S1 and S2. Here, while data stored in a predetermined region on a selected track is read, the first and second magnetic shield layers S1 and S2 cut off a magnetic field that is generated from a magnetic element surrounding the predetermined region and reaches the predetermined region. Generally, the magnetoresistance device 111 for data reproduction may have one of a giant magnetoresistance (GMR) structure and a tunnel magnetoresistance (TMR) structure.

The coil C shown in FIG. 1A vertically surrounds a region where the main pole P1 and the return yoke P2 meet each other. Such a coil structure is generally called a spiral coil structure. A perpendicular recording head having this coil structure has low field strength and high inductance. To address this problem, a structure, as illustrated in FIG. 1B, where a coil structure vertically formed between the main pole P1 and the first magnetic shield layer S1 is additionally provided has been proposed. The coil structure shown in FIG. 1B is called a dual pancake coil structure. However, the dual pancake coil structure shown in FIG. 1B has problems in that the inductance is still high and satisfactory field strength is difficult to obtain.

### SUMMARY OF THE INVENTION

The present invention provides a perpendicular magnetic head and a method of manufacturing the same, the perpendicular magnetic head including a solenoid type coil structure for optimizing a coil position in order to improve a recoding density.

According to an aspect of the present invention, there is provided a perpendicular magnetic head having a main pole, a return yoke, and a coil which generates a magnetic field such that the main pole records information on a recording medium, wherein the coil has a structure that surrounds the main pole in a solenoid shape.

The coil may include: a top coil which is formed in an upper portion of the main pole; a bottom coil which is formed in a lower portion of the main pole; and a connection portion which connects the top coil with the bottom coil to surround the main pole.

A portion of the top coil and/or bottom coil may be bent.

Each of the top coil and bottom coil may be formed of Cu.

The perpendicular magnetic head may further include a sub-yoke which is formed on a lateral side of the main pole to allow a magnetic field generated from the main pole to gather on a selected region of the recording medium during an information-recording process; and a magnetic shield layer which is spaced a distance from the sub-yoke to reduce an influence of a neighboring magnetic field during an information reproduction process, wherein the coil is located between the magnetic shield layer and the return yoke, and is formed in a solenoid shape which surrounds the main pole and sub-yoke.

The coil may be spaced a distance such that the coil does not contact the magnetic shield layer, sub-yoke, main pole, and return yoke; and a gap layer is formed on the main pole to physically separate an end of the main pole that faces an air bearing surface (ABS) from an end of the return yoke.

The perpendicular magnetic head may further include: a first insulating layer which is formed on the magnetic shield layer; a second insulating layer which is formed on the first insulating layer; and a third insulating layer which is formed on the gap layer, wherein the sub-yoke is formed on the second insulating layer, the main pole is formed on the sub-yoke, the bottom coil is located between the first and second insulating layers, the top coil is formed on the third insulating layer, and the return yoke is formed on the gap layer, the second insulating layer, and the top coil.

One of the first insulating layer, the second insulating layer, and the third insulating layer may be formed of one material selected from Bisbenzene Cyclobutene (BCB), Al₂O₃, and SiO₂.

The second insulating layer may be formed of BCB.

According to another aspect of the present invention, there is provided a method of manufacturing a perpendicular magnetic head, the method including: forming an insulating layer including a bottom coil on a magnetic shield layer and forming a first connection layer on both ends of the bottom coil; forming a sub-yoke and a second connection layer on the insulating layer; and forming a main pole on the sub-yoke, forming a third connection layer on the second connection layer, and forming a top coil connected to the third connection layer.

The forming of the insulating layer may include: forming a first insulating layer on the magnetic shield layer; forming the bottom coil on the first insulating layer; forming a second insulating layer on the first insulating layer and the bottom coil; and exposing both ends of the bottom coil and forming the first connection layer on both ends of the bottom coil.

The forming of the sub-yoke and the second connection layer may include: forming the sub-yoke and the insulating layer and forming the second connection layer on the first connection layer; coating an insulating material on the sub-yoke and planarizing the insulating material such that the sub-yoke is exposed.

The forming of the main pole may include: forming the main pole on the sub-yoke; forming a gap layer on the main pole and forming a return yoke tip on an end portion of the gap layer; forming the third connection layer on the second connection layer; coating an insulating material on the gap layer and the return yoke tip; planarizing the insulating material such that the return yoke tip is exposed; and forming the top coil connected to the third connection layer on the insulating material.

### BRIEF DESCRIPTION OF THE DRAWINGS

The above and other features and aspects of the present invention will become more apparent by describing in detail exemplary embodiments thereof with reference to the attached drawings in which:

FIGS. 1A and 1B are views illustrating a perpendicular magnetic recording apparatus including a related art perpendicular magnetic recording head;

FIG. 2 is a conceptual view illustrating a perpendicular magnetic recording apparatus including a perpendicular magnetic recording head according to an exemplary embodiment of the present invention;

FIG. 3 is a cross-sectional view of the perpendicular magnetic recording head of FIG. 2 according to an exemplary embodiment of the present invention;

FIGS. 4A and 4B are views, viewed from a top coil, illustrating a coil structure of the perpendicular magnetic recording head of FIG. 2, according to an exemplary embodiment of the present invention;

FIGS. 5A through 5M are cross-sectional views, taken along a line A-A′ of FIG. 4A, for explaining a method of manufacturing a perpendicular magnetic recording head according to an exemplary embodiment of the present invention;

FIGS. 6A through 6J are cross-sectional views, taken along a line B-B′ of FIG. 4A, for explaining a process of manufacturing a connection portion illustrated in FIG. 4A; and

FIGS. 7A and 7B are cross-sectional views illustrating images obtained after coating a BCB layer on an upper portion of a Cu coil and planarizing the BCB layer using CMP.

### DETAILED DESCRIPTION OF EXEMPLARY EMBODIMENTS OF THE INVENTION

The present invention will now be described more fully with reference to the accompanying drawings, in which exemplary embodiments of the invention are shown. In the drawings, the thicknesses of layers and regions are exaggerated for clarity.

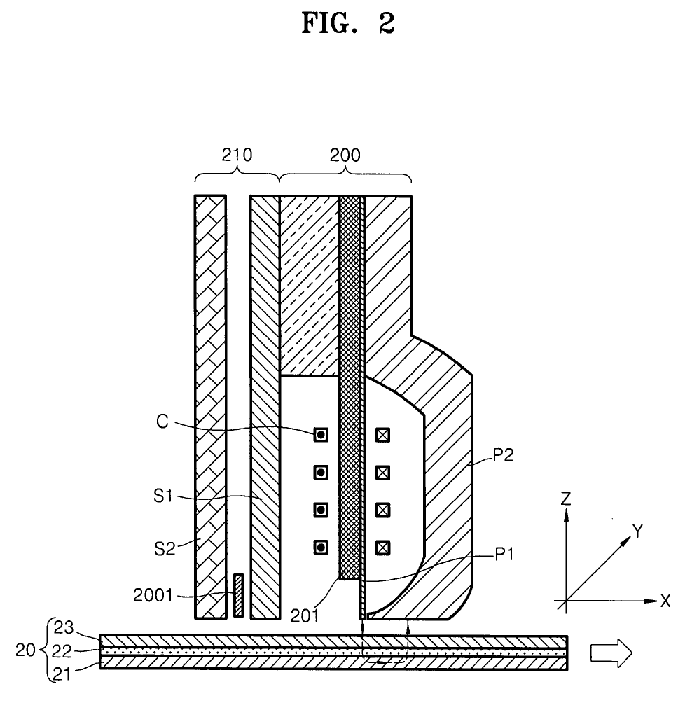

FIG. 2 is a conceptual view illustrating a perpendicular magnetic recording apparatus including a perpendicular magnetic recording head that has a solenoid type coil structure according to an exemplary embodiment of the present invention.

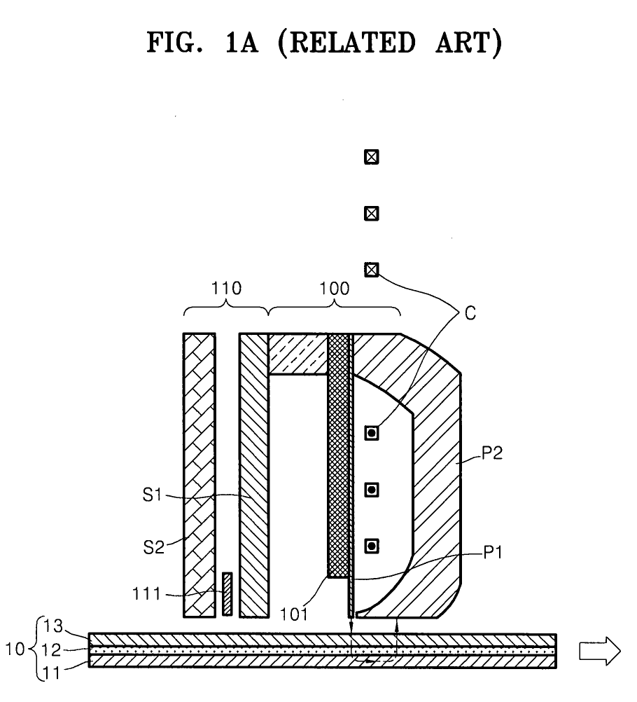

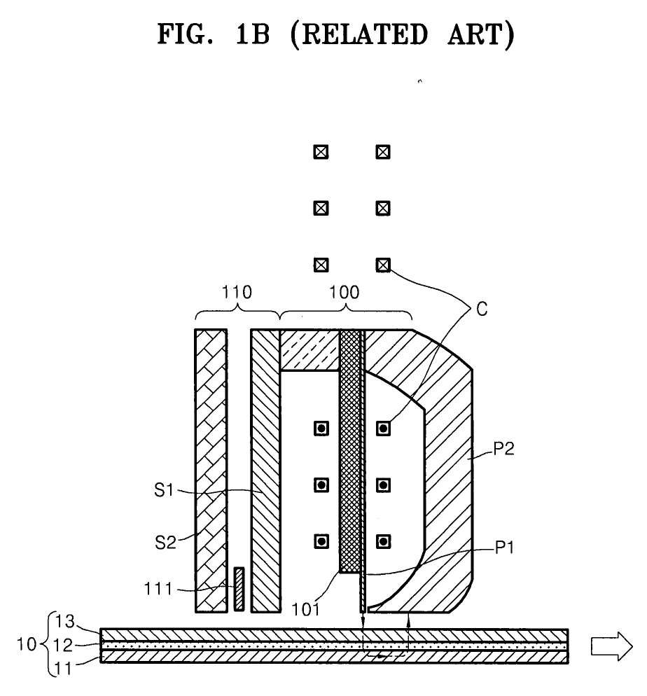

Referring to FIG. 2, the perpendicular magnetic recording apparatus includes a recording medium 20, a perpendicular magnetic recording head 200 recording data on the recording medium 20, and a perpendicular magnetic reproduction head 210 reproducing data form the recording medium 20. Here, the perpendicular magnetic recording head 200 includes a main pole P1, a return yoke P2, and a coil C generating an induction magnetic field of the main pole P1. Here, unlike the related art structure illustrated in FIGS. 1A and 1B, the coil C has a structure that surrounds a portion of the main pole P1 that is adjacent to an air bearing surface (ABS), which is a cross-sectional surface of the recording head 200 that faces the recording medium 20. Substantially, a sub-yoke 201 is formed on a lateral side of the main pole P1, and the coil C surrounds both the main pole P1 and the sub-yoke 201.

The perpendicular magnetic reproduction head 210 includes a first magnetic shield layer S1, a second magnetic shield layer S2, and a magnetoresistance device 2001 interposed between the first and second magnetic shield layers S1 and S2.

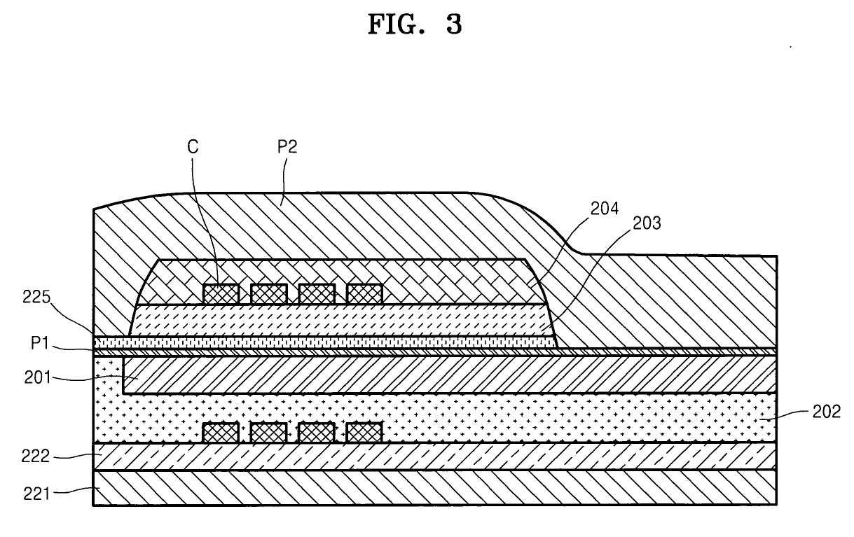

FIG. 3 is a cross-sectional view of the perpendicular magnetic recording head 200 according to an exemplary embodiment of the present invention. The coil C has been illustrated in a more exaggerating manner than in FIG. 2 in order to show a shape where the coil C surrounds the main pole P1, and a cross-section of the coil C is clearly illustrated in FIG. 3.

Referring to FIG. 3, a first insulating layer 222 is formed on a magnetic shield layer 221, and a portion of the coil C is formed on the first insulating layer 222. A second insulating layer 202 is formed on the coil C and lateral portions of the coil C. The sub-yoke 201 intended for increasing the recording field of the main pole P1 is formed in an upper side of the second insulating layer 202. Here, the sub-yoke 201 is formed in a single-layered region of the second insulating layer 202 such that the sub-yoke 201 is spaced apart by a predetermined distance from the ABS in order to increase the recording field of the main pole P1. The main pole P1 is formed on the sub-yoke 201, and the return yoke P2 is formed on the main pole P1. Here, a writing gap layer 225 is formed between the main pole P1 and the return yoke P2 in order to prevent a physical contact therebetween. The photoresist (PR) layer 204 is formed inside the ABS region of the writing gap layer 225.

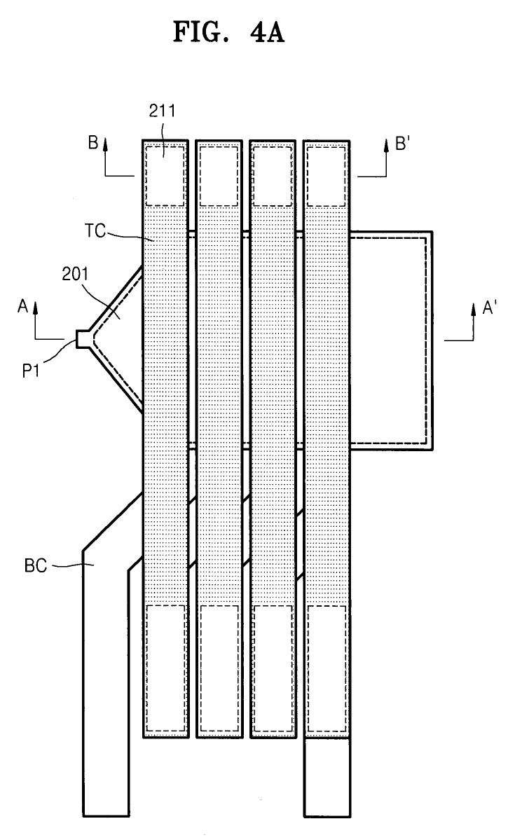

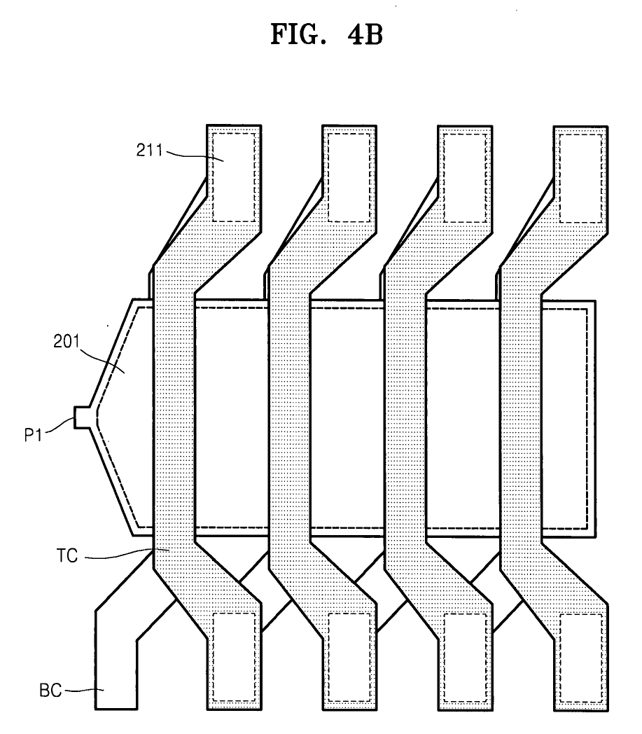

FIGS. 4A and 4B are views, viewed from a top coil, illustrating a coil structure of the perpendicular magnetic recording head 200, according to an exemplary embodiment of the present invention. Referring to FIGS. 4A and 4B, a coil formed on the main pole P1 is defined as a top coil (TC), while a coil formed under the main pole P1 is defined as a bottom coil (BC).

The TC and the BC are formed to be electrically connected to each other at a connection portion 211. Referring to FIG. 4A, the TC is formed in a straight-line shape and the BC is bent in order to achieve a solenoid shape. Referring to FIG. 4B, a portion of each of the TC and the BC is bent. Basically, the TC and the BC constitute a structure that surrounds the main pole P1 via the connection portion 211. Any structure may be applied to the coils as long as the coils induce a recording field to the main pole P1.

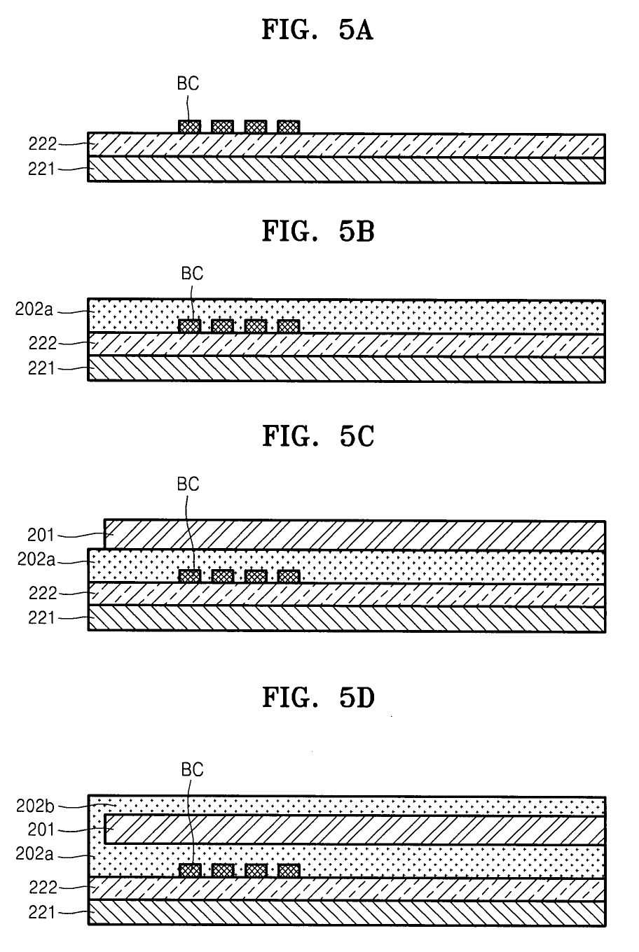

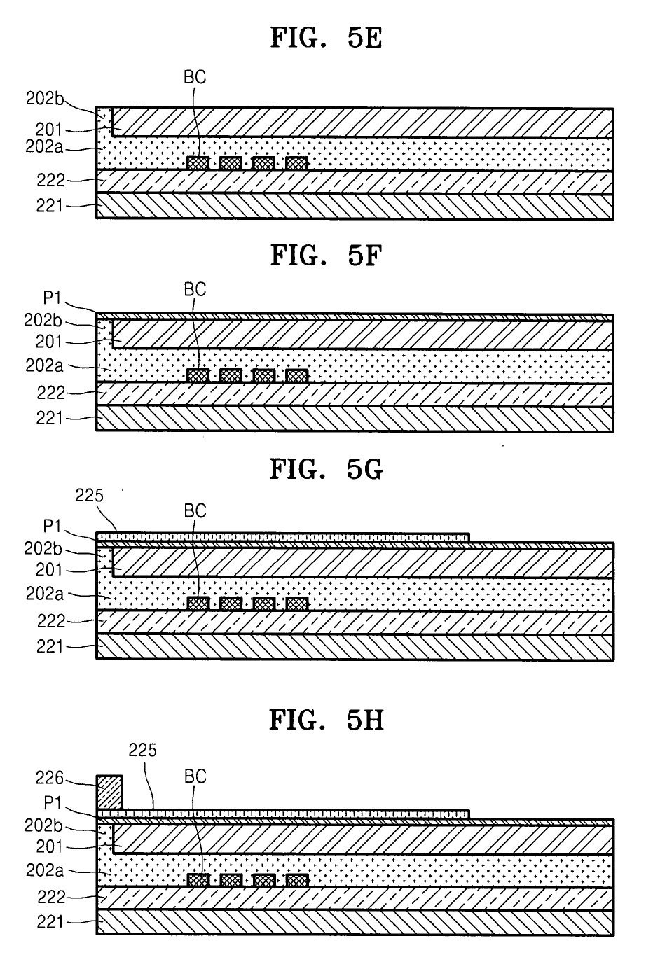

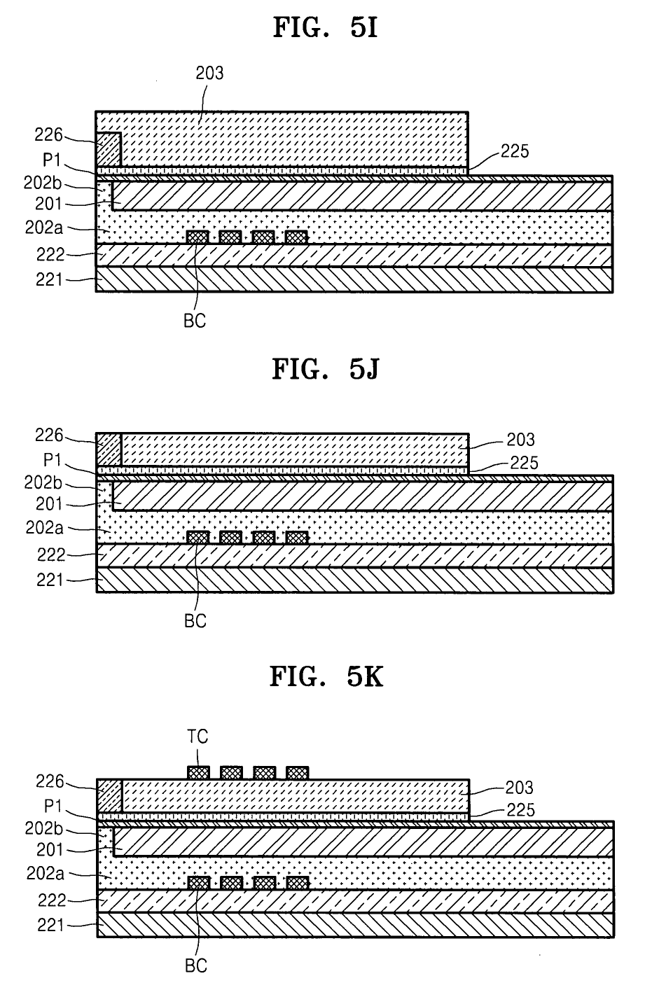

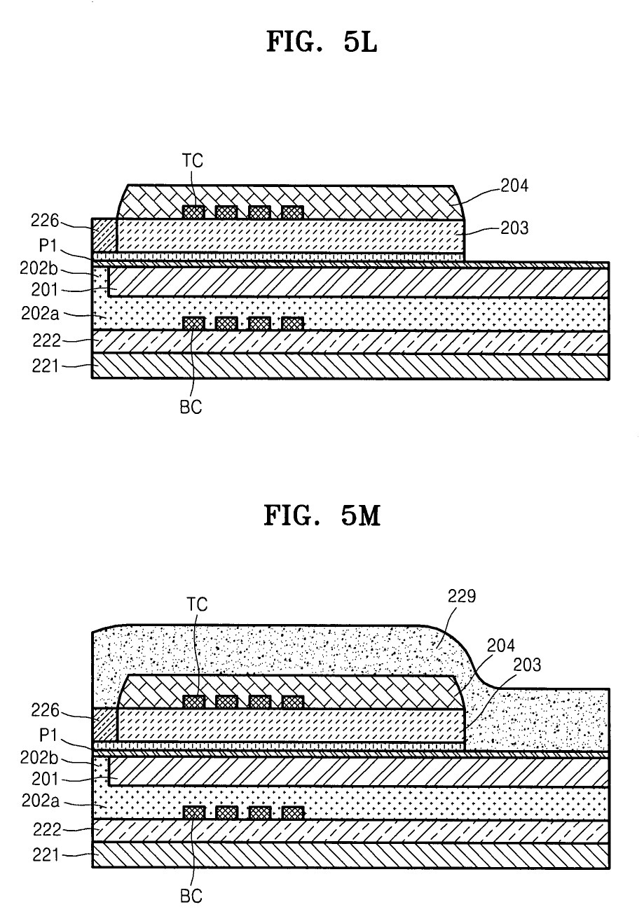

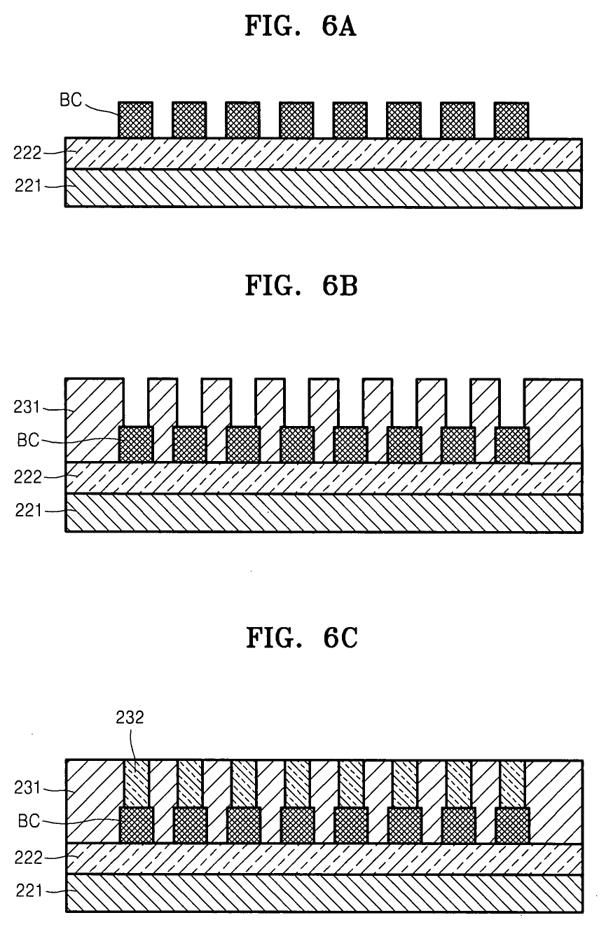

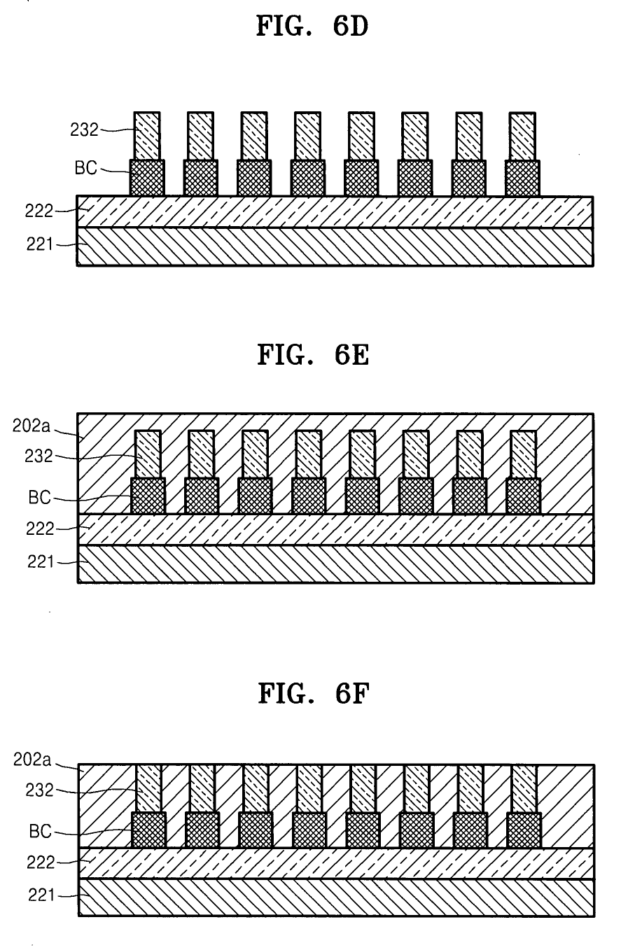

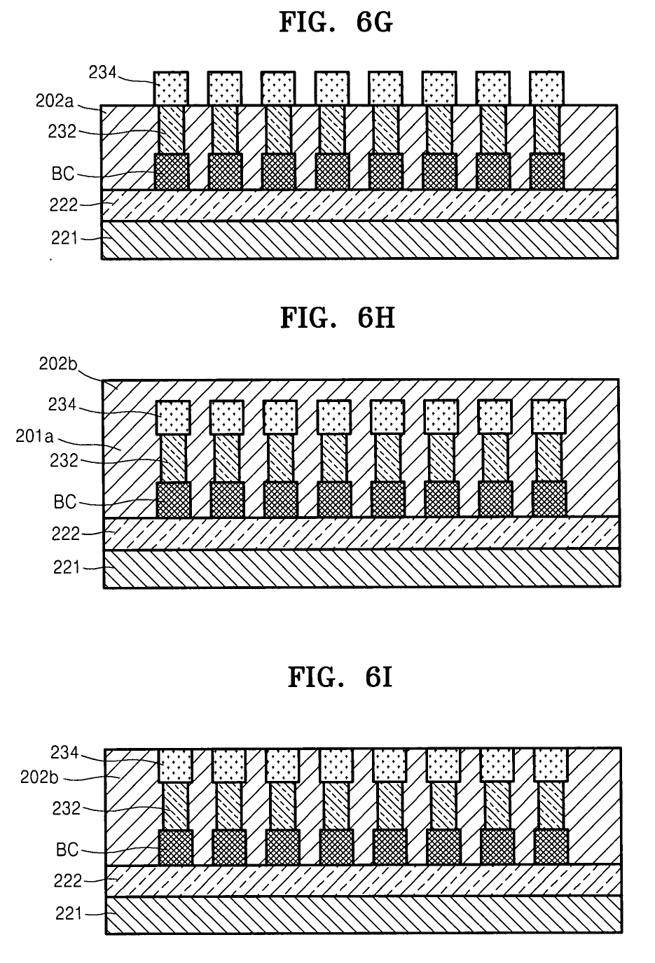

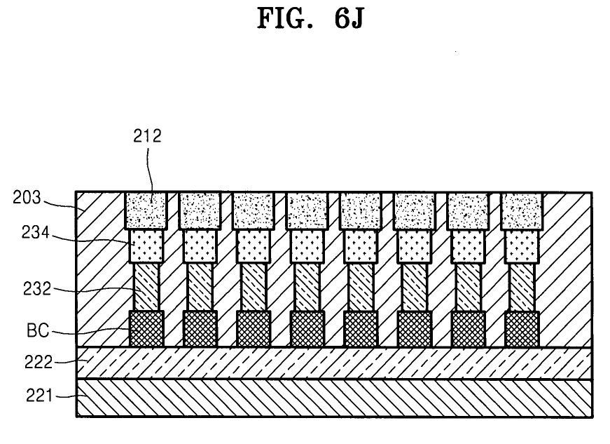

A method of manufacturing the perpendicular magnetic recording head 200 according to an exemplary embodiment of the present invention will be described in detail with reference to the accompanying drawings. FIGS. 5A through 5M are cross-sectional views, taken along line A-A′ of FIG. 4A, for explaining a process of manufacturing the perpendicular magnetic recording head 200 according to an exemplary embodiment of the present invention. FIGS. 6A through 6J are cross-sectional views, taken along line B-B′ of FIG. 4A, for explaining a process of manufacturing the connection portion 211 illustrated in FIG. 4A. It should be noted that the process illustrated in FIGS. 5A through 5M, and the process illustrated in FIGS. 6A through 6J are not independent process but performed during the same method of manufacturing the perpendicular magnetic recording head 200.

Referring to FIG. 5A, a first insulating layer 222 is formed on a magnetic shield layer 221 using one of BCB, SiO₂, and Al₂O₃. Conductive layer is plated with a material such as Cu, and a photoresist is removed so that the BC is formed. Referring to FIG. 5B, BCB is coated on the BC to form a lower portion 202a of a second insulating layer 202.

Referring to FIG. 5C, the lower portion 202a of the second insulating layer 202 is planarized using a chemical mechanical polishing (CMP) process, and the sub-yoke 201 is formed on the lower portion 202a of the second insulating layer 202. Here, a left end of FIG. 5C is for an ABS facing a perpendicular magnetic recording medium, and the sub-yoke 201 may be spaced a predetermined interval from the ABS for concentrating a recording field of the main pole P1 that will be formed later.

Referring to FIG. 5D, one of BCB, SiO₂, and Al₂O₃ is coated on a left end and an upper surface of the sub-yoke 201 to form an upper portion 202b of the second insulating layer 202. The BCB may be used. Referring to FIG. 5E, the upper portion 202b of the second insulating layer 202 on the sub-yoke 201 is removed using a CMP process to expose a surface of the sub-yoke 201.

Referring to FIG. 5F, the main pole P1 is formed on the sub-yoke 201 and the upper portion 202b of the second insulating layer 202. The main pole P1 is formed of a magnetic material such as CoNiFe or CoFe. Referring to FIG. 5G, a writing gap layer 225 formed of an insulating material is formed using a lift-off process in a region that excludes a right end of the main pole P1 and the connection portion 211.

Referring to FIG. 5H, a magnetic material is formed on the writing gap layer 225 to form a return pole tip 226 on a left end of the main pole P1. Referring to FIGS. 51 and 5J, BCB is coated on the return yoke tip 226 to form a third insulating layer 203, and the return yoke tip 226 is exposed using a CMP process.

Referring to FIG. 5K, the TC is formed on the third insulating layer 203. Referring to FIG. 5L, a PR is coated on the TC, and a heat treatment is performed to form a cured PR layer 204.

Referring to FIG. 5M, a magnetic material is coated on the return yoke tip 226, the PR layer 204, and the main pole P1 to form a return yoke P2. The return yoke P2 can be formed of the same material as that of the magnetic shield layer 221.

A process of forming a connection layer connecting the BC with the TC as described in FIGS. 5A through 5M will be described with reference to FIGS. 6A through 6J. FIGS. 5A through 5M illustrate an exemplary embodiment where four TCs and four BCs are provided. Though FIGS. 6A through 6J illustrate eight TCs and eight BCs, the number of the coils may change. The number of turns of the coils around the main pole P1 may be arbitrarily selected.

Referring to FIG. 6A, the first insulating layer 222 is formed on the magnetic shield layer 221, and the BC is formed on the first insulating layer 222. The process shown in FIG. 6A is the same as that shown in FIG. 5A. Next, a PR 231 is coated and pattering is performed as illustrated in FIG. 6B.

Referring to FIG. 6C, the BC inside the patterned PR 231 is plated with metal to form a first connection layer 232. The PR 231 is removed using PR stripping as illustrated in FIG. 6D.

Referring to FIG. 6E, BCB is coated to form a lower portion 202a of the second insulating layer 202. A process shown in FIG. 6E is the same as that illustrated in FIG. 5B. Referring to FIG. 6F, surface planarization is performed using a CMP process to expose the first connection layer 232. Referring to FIG. 6G, the first connection layer 232 is plated with metal to form a second connection layer 234

Referring to FIG. 6H, BCB is coated to form another upper portion 202b of the second insulating layer 202. A process shown in FIG. 6H is the same as that illustrated in FIG. 5D. Next, a surface of the upper portion 202b of the second insulating layer 202 is planarized using a CMP process as illustrated in FIG. 61. A process shown in FIG. 61 is the same as that shown in FIG. 5E. That is, BCB is coated on the sub-yoke 201 to form the upper portion 202b of the second insulting layer, and the sub-yoke 201 is exposed using a CMP process with the second connection layer 234 exposed as illustrated in FIG. 61.

Referring to FIG. 6J, the second connection layer 234 is plated with metal to form a third connection layer 212, BCB is coated to form a third insulating layer 203, and planarization is performed using a CMP process. A process shown in FIG. 6J is the same as that shown in FIG. 5J. Next, when an end of the TC is joined to the third connection layer 212 while the TC is formed as illustrated in FIG. 5K, a structure where the BC and the TC are connected to each other as illustrated in FIG. 4A is completed.

The manufacturing processes disclosed in FIGS. 5A through 5M, and FIGS. 6A through 6J can be summarized in a single process as follows.

First, the first insulating layer 222 and the lower portion 202a of the second insulating layer 202 including the BC are formed on a lower structure including the magnetic shield layer 221. Next, the first connection layer 232 connected to both ends of the BC is vertically formed, the sub-yoke 201 is formed on the first insulating layer 222 and the lower portion 202a of the second insulating layer 202 including the BC, and simultaneously or subsequently, the second connection layer 234 is formed on the first connection layer 232. Next, the upper portion 202b of the second insulating layer 202 is formed by coating BCB, a planarization process is performed, and the main pole P1 is formed on the sub-yoke 201. After the main pole P1 is formed, the third connection layer 212 is formed on the second connection layer 234, the third insulating layer 203 is coated on the gap layer and return yoke tip, and the TC is formed on the third insulating layer 203. After that, a process of forming the return yoke P2 can be easily performed using a process from related art perpendicular magnetic recording head related technologies.

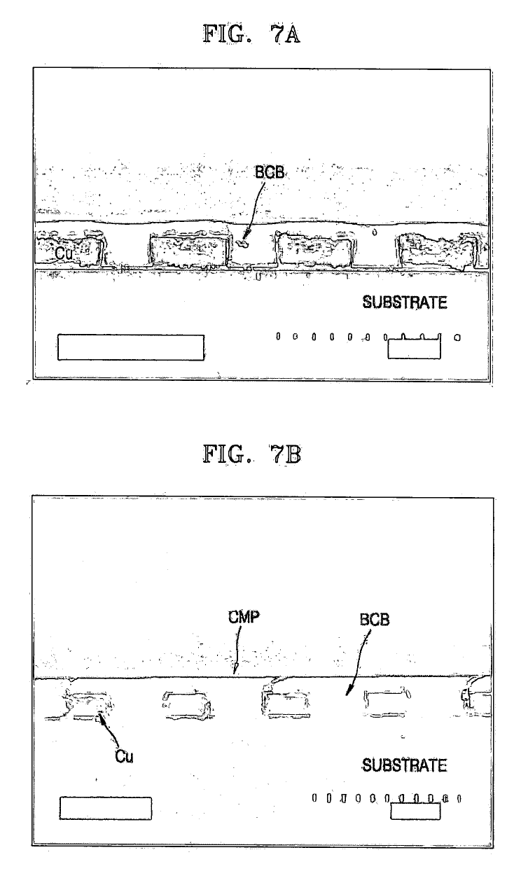

FIG. 7A is a view of an image showing BCB used for an insulating layer and a planarization material is formed on a coil, and FIG. 7B is a view illustrating an image obtained after a CMP process is performed. A test piece used in FIG. 7A is formed by coating a substrate using Cu and patterning the coated substrate, coating BCB on the pattern substrate, and performing a baking process on the BCB-coated substrate at a temperature of 250° C. for one hour in a vacuum state. Though a separate planarization process has not been performed, a relatively clean surface having no large step between coils is obtained. Referring to FIG. 7B, when a CMP process is performed on BCB, planarization is performed very effectively.

An oxide such as BCB, PR, and SiO₂ can be used for an insulating material. The PR has an advantage in planarizing after coating but is difficult to perform a CMP process. In the case of the SiO₂, a CMP process can be performed, but when a deposition process is performed, planarization is not easily performed. Therefore, in the case of forming an insulating layer and performing a CMP process, the BCB is used rather than the PR and the SiO₂. In a process for forming a perpendicular magnetic recording head according to an exemplary embodiment of the present invention, using the BCB, the second and third insulating layers 202 and 203 may be formed where a planarization process is particularly important after an insulating material is coated.

According to exemplary embodiments of the present invention, a coil having a solenoid structure is formed around a portion of a main pole that is adjacent to an ABS, so that inductance of a perpendicular magnetic recording head is reduced and high field strength can be obtained. Therefore, the recording density of data may improve when data is recorded on a disc. Also, in an aspect of a manufacturing process of the present invention, a coil having a solenoid structure can be formed around a main pole using a simple method, and BCB having an advantage for planarization and a CMP process is used, so that a perpendicular magnetic recording head having a stable structure is provided.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, the structures of the main pole P1 and the return yoke P2 of a perpendicular magnetic recording head may be modified, and more coils than the coils shown in the drawings may be used.

What is claimed is:

1. A perpendicular magnetic recording head comprising:
a main pole,
a return yoke,
and a coil which generates a magnetic field such that the main pole records information on a recording medium,
wherein the coil has a structure that surrounds the main pole in a solenoid shape.

2. The perpendicular magnetic recording head of claim 1, wherein the coil comprises:
a top coil which is formed in an upper portion of the main pole;
a bottom coil which is formed in a lower portion of the main pole; and
a connection portion which connects the top coil with the bottom coil to surround the main pole.

3. The perpendicular magnetic recording head of claim 2, wherein a portion of each of the top coil and/or bottom coil is bent.

4. The perpendicular magnetic recording head of claim 2, wherein each of the top coil and the bottom coil is formed of Cu.

5. The perpendicular magnetic recording head of claim 3, wherein each of the top coil and the bottom coil is formed of Cu.

6. The perpendicular magnetic recording head of claim 1, further comprising:
a sub-yoke which is formed on a lateral side of the main pole to allow a magnetic field generated from the main pole to gather on a selected region of the recording medium during an information-recording process; and
a magnetic shield layer which is spaced a distance from the sub-yoke to reduce an influence of a neighboring magnetic field during an information reproduction process,
wherein the coil is located between the magnetic shield layer and the return yoke, and is formed in a solenoid shape which surrounds the main pole and the sub-yoke.

7. The perpendicular magnetic recording head of claim 2, further comprising:
a sub-yoke which is formed on a lateral side of the main pole to allow a magnetic field generated from the main pole to gather on a selected region of the recording medium during an information-recording process; and
a magnetic shield layer which is spaced a distance from the sub-yoke to reduce an influence of a neighboring magnetic field during an information reproduction process,
wherein the coil is located between the magnetic shield layer and the return yoke, and is formed in a solenoid shape which surrounds the main pole and the sub-yoke.

8. The perpendicular magnetic recording head of claim 6, wherein the coil is spaced a distance such that the coil does not contact the magnetic shield layer, the sub-yoke, the main pole, and the return yoke, and
a gap layer is formed on the main pole to physically separate an end of the main pole that faces an air bearing surface (ABS) from an end of the return yoke.

9. The perpendicular magnetic recording head of claim 8, further comprising:
a first insulating layer which is formed on the magnetic shield layer;
a second insulating layer which is formed on the first insulating layer; and
a third insulating layer which is formed on the gap layer,
wherein the coil comprises a top coil which is formed in an upper portion of the main pole and a bottom coil which is formed in a lower portion of the main pole, the sub-yoke is formed on the second insulating layer, the main pole is formed on the sub-yoke, the bottom coil of the coil is located between the first and second insulating layers, the top coil is formed on the third insulating layer, and the return yoke is formed on the gap layer, the third insulating layer, and the top coil.

10. The perpendicular magnetic recording head of claim 9, wherein one of the first insulating layer, the second insulating layer, and the third insulating layer is formed of one material selected from Bisbenzene Cyclobutene (BCB), Al₂O₃, and SiO₂.

11. The perpendicular magnetic recording head of claim 9, wherein the second insulating layer is formed of Bisbenzene Cyclobutene (BCB).

12. A method of manufacturing a perpendicular magnetic recording head, the method comprising:
forming an insulating layer including a bottom coil on a magnetic shield layer and forming a first connection layer on both ends of the bottom coil;
forming a sub-yoke and a second connection layer on the insulating layer; and
forming a main pole on the sub-yoke, forming a third connection layer on the second connection layer, and
forming a top coil connected to the third connection layer.

13. The method of claim 12, wherein the forming of the insulating layer comprises:
forming a first insulating layer on the magnetic shield layer;
forming the bottom coil on the first insulating layer;
forming a second insulating layer on the first insulating layer and the bottom coil; and
exposing both ends of the bottom coil and forming the first connection layer on both ends of the bottom coil.

14. The method of claim 12, wherein the forming of the sub-yoke and the second connection layer comprises:
forming the sub-yoke and the insulating layer and forming the second connection layer on the first connection layer; and
coating an insulating material on the sub-yoke and planarizing the insulating material to expose the sub-yoke.

15. The method of claim 12, wherein the forming of the main pole comprises:
forming the main pole on the sub-yoke;
forming a gap layer on the main pole and forming a return yoke tip on an end portion of the gap layer;
forming the third connection layer on the second connection layer;
coating an insulating material on the gap layer and the return yoke tip; and
forming the top coil connected to the third connection layer on the insulating material.

16. The method of claim 13, wherein the second insulating layer is formed of Bisbenzene Cyclobutene (BCB).

17. The method of claim 13, wherein the first insulating layer is formed of one material selected from Bisbenzene Cyclobutene (BCB), Al₂O₃, and SiO₂.
